(19) United States
(12) Patent Application Publication
(10) Pub. No.: US 2011/0081126 A1
(43) Pub. Date: Apr. 7, 2011

(54) IMAGE PROCESSING APPARATUS AND IMAGE PROCESSING METHOD

(75) Inventor: Maki Mizuno, Tokyo (JP)

(73) Assignee: CANON KABUSHIKI KAISHA, Tokyo (JP)

(21) Appl. No.: 12/896,261

(22) Filed: Oct. 1, 2010

(30) Foreign Application Priority Data
Oct. 5, 2009 (JP) 2009-231767

(51) Int. Cl. H04N 5/775

(52) U.S. Cl. 386/230; 386/E05.07

(57) ABSTRACT

An image processing apparatus includes a drawing reading unit configured to read a drawn line on a display, an extraction target still image determination unit configured to determine a point for extracting a still image from moving image data according to a locus read by the drawing reading unit, a still image extraction unit configured to extract a still image from the moving image data based on a point determined by the extraction target still image determination unit, and a still image display unit configured to display a still image extracted by the still image extraction unit, on the locus of the display.

### BACKGROUND OF THE INVENTION

1. Field of the Invention

The present invention relates to an image processing apparatus and an image processing method and particularly, a proper technique for extracting a still image from moving image content and laying out the extracted still image.

2. Description of the Related Art

Recently, various portable terminals capable of reproducing a moving image content, such as portable video audio reproduction players, and in addition handy phones, personal digital assistants (PDA), and notebook personal computers (PC), have been developed, and users can view a moving image content under every environment.

However, a user does not know what kind of content is recorded on which portion of a moving image to be reproduced. Therefore, when a user wants to judge contents of the moving image content, he needs to reproduce the contents of the moving image, so that very cumbersome operations are required for reproducing a desired moving image.

As for a method to resolve the aforementioned inconvenience, for example, Japanese Patent Application Laid-Open No. 8-18923 discuses an image reproduction apparatus for reproducing a moving image. In the image reproduction apparatus, in reproducing the moving image, a plurality of parts is taken out from one moving image content as still images, the removed still images are displayed on, for example, 9 divided display screens respectively, one of the displayed still images is selected, and the moving image is reproduced from positions of the selected still images. Further, Japanese Patent Application Laid-Open No. 2004-193635 discusses a method for dividing the display screen according to a number of extracted frame images and displaying the extracted frame image on the divided display screen respectively.

However, in such conventional techniques, a layout of still images and thumbnails, which are extracted from a moving image content, has been automatically determined. Thus, there is a problem that a size and a layout of an image desired by a user must be set separately.

### SUMMARY OF THE INVENTION

The present invention is directed to a technique for enabling easy extraction of still images and easily performing a layout of them when a user extracts the still images from a moving image content.

According to an aspect of the present invention, an image processing apparatus of the present invention includes a drawing reading unit configured to read a line drawn on a display, an extraction target still image determination unit configured to determine a point for extracting a still image from moving image data based on a locus read by the drawing reading unit, a still image extraction unit configured to extract a still image from the moving image data based on a point determined by the extraction target still image determination unit, and a still image display unit configured to display a still image extracted by the still image extraction unit, on the locus of the display.

According to the present invention, the image processing apparatus extracts a moving image content from a locus drawn by a user and performs a layout of still images on the locus. By taking such a configuration, a user does not need to determine an image position and an image size of each still image, so that a desired layout is achieved with an easy operation. Further, a user can grasp contents of a moving image content in one glance.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1A is a block diagram illustrating a configuration example of an image processing apparatus according to a first exemplary embodiment.

FIG. 1B illustrates an example of data for determining an extraction point of a still image according to the first exemplary embodiment.

FIG. 2 is a flowchart illustrating a procedure of the image processing apparatus according to the first exemplary embodiment.

FIG. 3A is a block diagram illustrating a configuration example of a second exemplary embodiment.

FIG. 3B illustrates an example of data for determining an extraction point of a still image according to the second exemplary embodiment.

FIG. 4 is a flowchart illustrating a procedure according to the second exemplary embodiment.

FIG. 5 is a block diagram illustrating a configuration example of a third exemplary embodiment.

FIG. 6 is a flowchart illustrating a procedure according to the third exemplary embodiment.

FIG. 7 is a flowchart illustrating a procedure according to a fourth exemplary embodiment.

FIG. 8A illustrates an example in which a locus is a polygonal line according to the fourth exemplary embodiment.

FIG. 8B illustrates an example in which a locus is a circle according to the fourth exemplary embodiment.

FIG. 8C illustrates an example of data according to the fourth exemplary embodiment.

### DESCRIPTION OF THE EMBODIMENTS

Various exemplary embodiments, features, and aspects of the invention will be described in detail below with reference to the drawings.

A first exemplary embodiment of the present invention will be described below with reference to figures and a flowchart. However, a technical scope of the present invention is not limited by the exemplary embodiment.

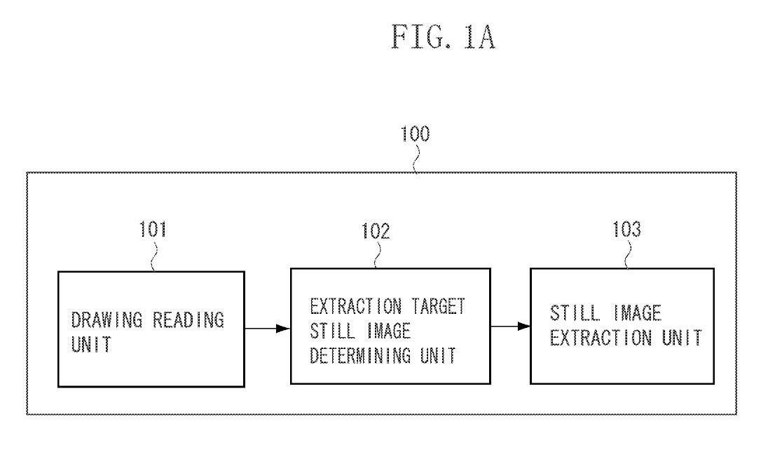

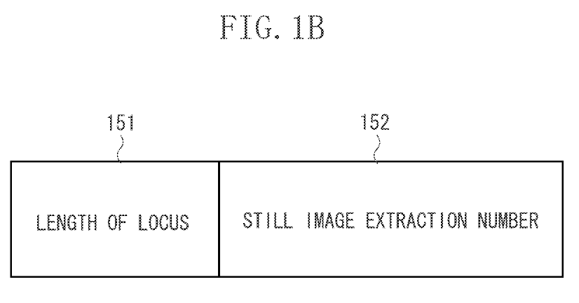

FIG. 1A is a block diagram illustrating a configuration example of the first exemplary embodiment of an image processing apparatus. In FIG. 1A, an image processing apparatus 100 includes a drawing reading unit 101, an extraction target still image determination unit 102, and a still image extraction unit 103.

The drawing reading unit 101 reads, for example, a locus drawn on a table-type display and determines a length of the locus. A determination method of the length of the locus is to calculate from coordinates of two points if the locus is a line. For example, when position vectors of the two points are p₁=(x₁, y₁, z₁) and p₂=(x₂, y₂, z₂), a length between these two points can be calculated by using the following formula (1).

d=\sqrt{(x₂−x₁)²+(y₂−y₁)²+(z₂−z₁)²} (1)

Further, if the locus is circle, a length can be calculated by using a radius and an interior angle. Furthermore, if the locus is a Bezier curve, a length can be calculated by using the following formula (2).

∫_{b}^{a}{square root over ((x′(t))²+(y′(t))²)}dt a≦t≦b (2)

where, a base is x′(t) and a height is y′(t).

Furthermore, a length can be calculated by a total dots number of a drawn locus. Since there are many methods for calculating a length of a locus, there will be no descriptions more in the exemplary embodiment. The extraction target still image determination unit 102 performs mapping a moving image content which becomes a still image drawing target and a length of a locus which is calculated by the drawing reading unit 101 and drawn on a display, and determines a point of a still image extracted from moving image data of a moving image content.

The still image extraction unit 103 extracts a still image from a moving image content based on the point determined by the extraction target still image determination unit 102.

FIG. 1B illustrates an example of data for determining an extraction point of a still image by the extraction target still image determination unit 102 according to the first exemplary embodiment of the present invention.

As illustrated in FIG. 1B, the image processing apparatus 100 stores a length of a locus 151 and a still image extraction number 152 as data in the first exemplary embodiment. The drawing reading unit 101 acquires the length of a locus 151 drawn on the display and acquires the still image extraction number 152 corresponding to the length of the locus 151. The extraction target still image determination unit 102 extracts a still image from a moving image content at a constant interval based on the still image extraction number 152.

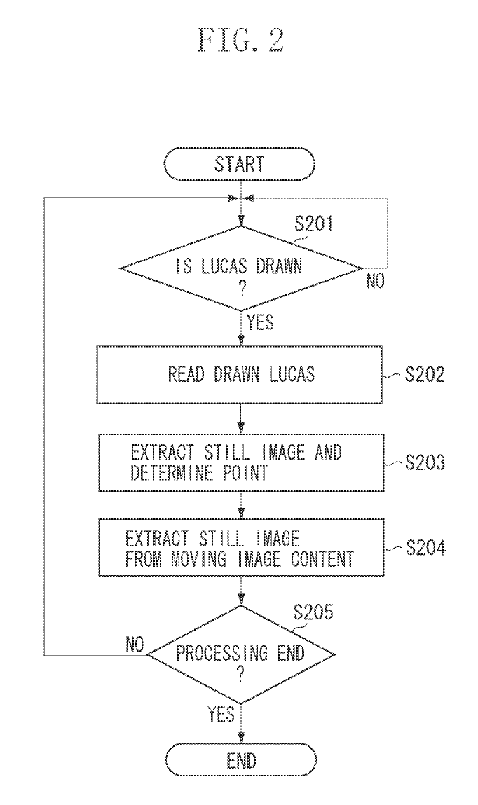

FIG. 2 is a flowchart illustrating an example of a procedure according to the first exemplary embodiment. The processing of the exemplary embodiment will be described according to the flowchart as follows.

In step S201, the image processing apparatus 100 determines whether a locus is drawn on a display by a user. From the result of the determination, when the locus is drawn, the processing proceeds to step S202, and when the locus is not drawn, the processing enters a stand-by state.

In step S202, the drawing reading unit 101 reads the locus drawn on the display and identifies a length of a locus.

In step S203, the drawing reading unit 101 performs mapping of the identified length of a locus, and a start point and an end point of a target moving image content, and then the extraction target still image determination unit 102 determines a point for extracting the still image.

In step S204 the still image extraction unit 103 extracts the still image based on the still image extraction point determined by the extraction target still image determination unit 102.

In step S205, the image processing apparatus 100 makes an end determination. This determination is made based on whether a user performs end processing. In the end processing, for example, a power source is turned off. From the result of the determination in step S205, when the processing does not end, the processing returns to step S201 and the image processing apparatus 100 performs the aforementioned processing. Further, when the processing ends, the image processing apparatus 100 performs the end processing.

A second exemplary embodiment will be described mainly about a difference from the first exemplary embodiment as follows. In the second exemplary embodiment, the same reference numerals and letters refer to the same items in configurations as the first exemplary embodiment and a detailed description will be omitted. However, the technical scope of the present invention is not limited by the second exemplary embodiment.

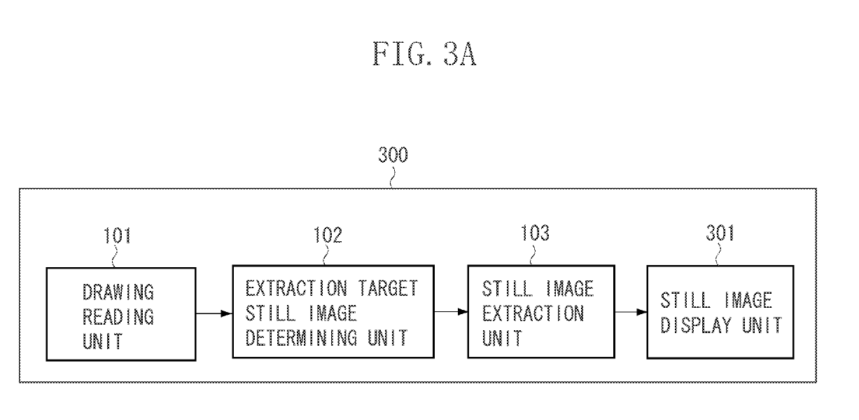

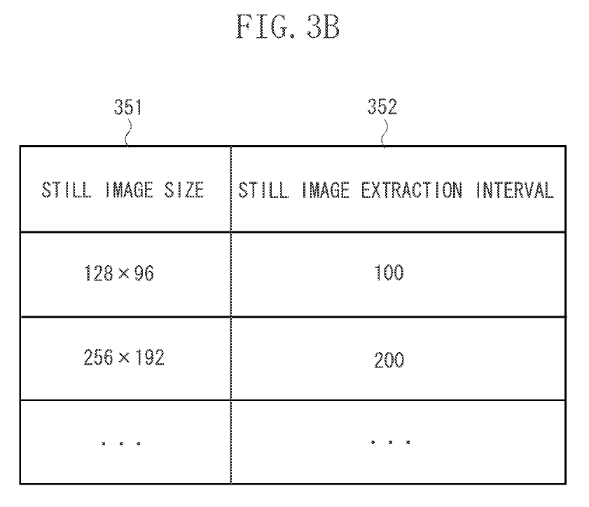

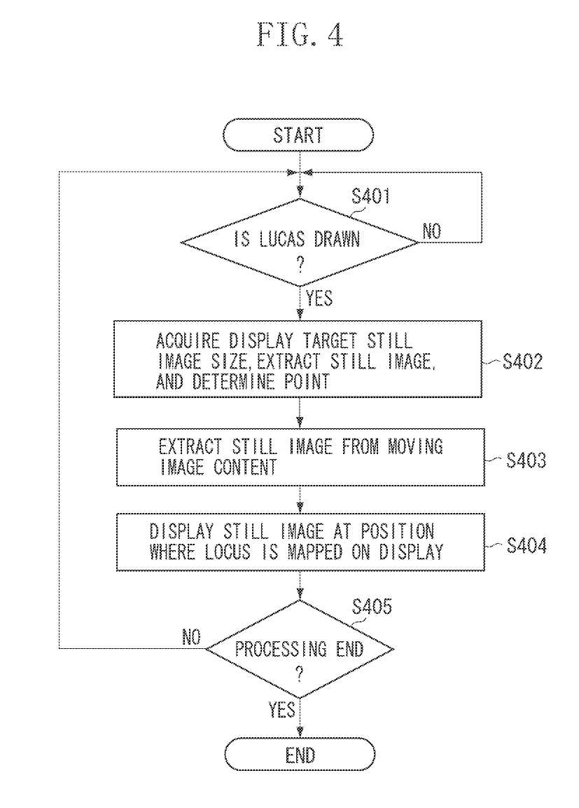

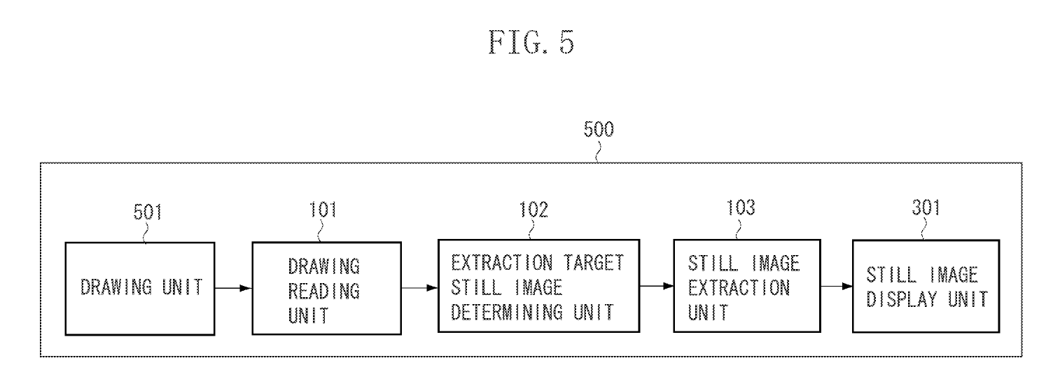

FIG. 3A is a block diagram illustrating a configuration example according to the second exemplary embodiment of the present invention. In FIG. 3A, the image processing apparatus 300 of the second exemplary embodiment includes a still image display unit 301 in addition to the configuration of the image processing apparatus 100 illustrated in FIG. 1A. The still image display unit 301 displays a still image extracted by the still image extraction unit 103, on a locus.

FIG. 3B illustrates an example of data for determining an extraction point of a still image by the extraction target still image determination unit 102 in the second exemplary embodiment. In FIG. 3B, a still image size 351 indicates a size of a still image extracted from a moving image content. The still image size 351 described in FIG. 3B can be either an actual still image size or a thumbnail size at a time of displaying the image. A still image extraction interval 352 is an interval for extracting an extracted still image.

Then, one example of the procedure for extracting a still image from a moving image content till displaying the still image on a display is described using a flowchart in FIG. 4. However, the technical scope of the present invention is not limited to the exemplary embodiment.

In step S401, the image processing apparatus 300 determines whether a locus is drawn on a display by a user. From the result of the determination, when the locus is drawn, the processing proceeds to step S402, and when the locus is not drawn, the processing enters a stand-by state.

In step S402, the extraction target still image determination unit 102 acquires a still image size 351 to be displayed and determines a point for extracting the still image from a moving image content based on a still image extraction interval 352 corresponding to the still image size 351.

In step S403, the still image extraction unit 103 extracts the still image based on the point determined by the extraction target still image determination unit 102.

In step S404, the still image display unit 301 displays the still image at a position where mapping the point extracted by the still image extraction unit 103 and the locus on the display are performed.

In step S405, the image processing apparatus 300 performs final determination. The determination is performed based on whether a user performs end processing. In the end processing, for example, a power source can be turned off. As a result of the determination in step S405, when the processing does not end, the processing returns to step S401 and performs the aforementioned processing. Further, when the processing ends, the processing performs the end processing.

A third exemplary embodiment will be described as follows. In the present embodiment, a method for determining a point for extracting a still image according to quickness of a drawn locus is described. However, the technical scope of the present invention is not limited to the exemplary embodiment.

To determine a point for extracting a extraction target still image from a moving image content according to quickness of a locus, the extraction target still image determination unit 102 uses information at a time of drawing locus.

For example, when a user draws a locus using a pointing device, such as a mouse, the drawing image unit 501 records coordinates and time of the pointing device for every predetermined time. Then, the drawing reading unit 101 performs mapping of a time rate of a record sequence and a length of the moving image content, and the extraction target still image determination unit 102 determines a point for extracting a still image.

FIG. 5 is a block diagram illustrating a configuration example of an image processing apparatus 500 according to the third exemplary embodiment.

In the image processing apparatus 500 of the third exemplary embodiment, the drawing unit 501 represents a pointing device, such as a mouse, and records information, such as a coordinate and time, at a time of drawing a locus.

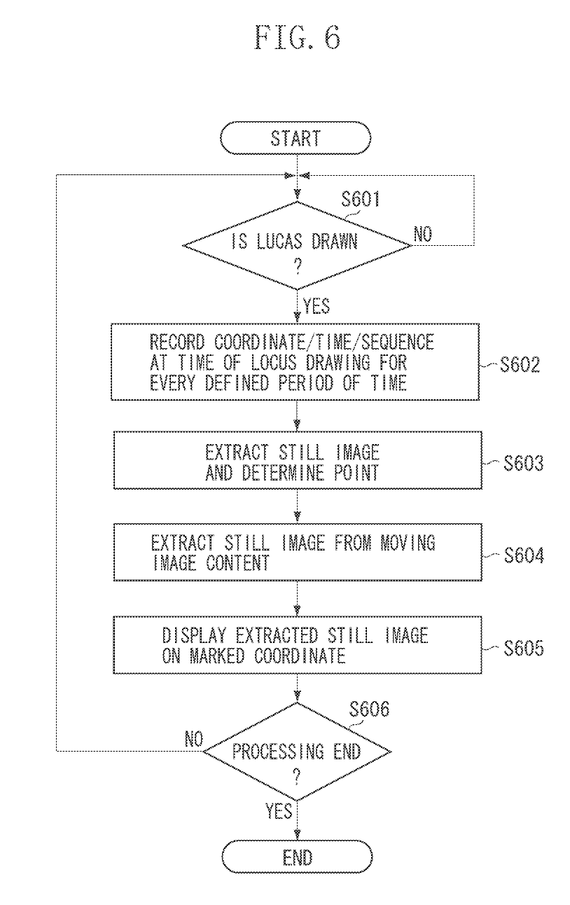

FIG. 6 is a flowchart illustrating a procedure for determining a point for extracting a still image according to quickness of the drawn locus, which is the third exemplary embodiment. The exemplary embodiment is described along the flowchart as follows.

In step S601, the image processing apparatus 500 determines whether a locus is drawn on a display by a user. From the result of the determination, when the locus is drawn, the processing proceeds to step S602. When the locus is not drawn, the processing becomes a stand-by state.

In step S602, the drawing unit 501 performs marking of coordinates for every predetermined time at a time of drawing a locus. Further the drawing unit 501 records time and a sequence simultaneously with the marking.

In step S603, the extraction target still image determination unit 102 calculates a time ratio which records each coordinate from the recorded sequence and time, and performs mapping of the time ratio and time of a moving image content, so that the extraction target still image determination unit 102 determines a point for extracting the still image from the moving image content.

In step S604, the still image extraction unit 103 extracts the still image at the extraction point determined by the extraction target still image determination unit 102 from the moving image content.

In step S605, the still image display unit 301 displays the still image on the coordination where the marking is performed at a time of drawing the locus.

In step S606, the image processing apparatus 500 determines whether the processing ends. As the result of the determination, if the processing does not end, the processing returns to step S601. If the processing ends, the image processing apparatus performs end processing.

The fourth exemplary embodiment will be described as follows. The feature of the fourth exemplary embodiment is to determine a point for extracting a still image according to a shape of a drawn locus. Concretely speaking, to determine a point for extracting a still image according to a shape of a drawn locus, the image processing apparatus associates drawing information, such as a line, a polygonal line, circle, and curve, as a attribute of the locus, and determines a still image extraction point according to each kind of drawings.

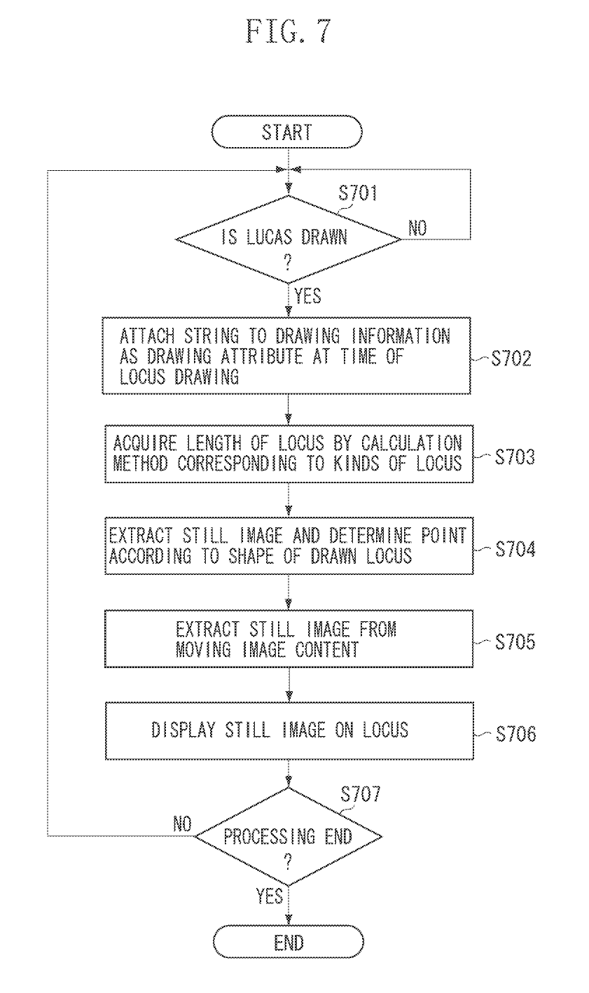

FIG. 7 is a flowchart illustrating a procedure to determine a point for extracting a still image according to a shape of a drawn locus, which is the fourth exemplary embodiment.

In step S701, the image processing apparatus determines whether a locus is drawn on a display by a user. From the result of the determination, if the locus is drawn, the processing proceeds to step S702. If the locus is not drawn, the image processing apparatus enters a stand-by state.

In step S702, the drawing unit 501 records a kind of a locus as an attribute in association with the locus at a time of drawing the locus.

In step S703, the image reading unit 101 reads the locus and calculates a length of the locus from a kind of the associated locus by a calculation method corresponding to the locus.

In step S704, the extraction target still image determination unit 102 performs mapping of a start point and a end point on the length of the locus and the moving image content, and determines a point for extracting the still image according to the shape of the drawn locus.

In step S705, the still image extraction unit 103 extracts a still image at the extraction point determined from the moving image content.

In step S706, the still image display unit 301 performs mapping of the determined extraction point and a position of the drawn locus, and displays the still image.

In step S706, the image processing apparatus 500 determines whether the processing ends. As the result of the determination, if the processing does not end, the processing returns to step S701. If the processing ends, the image processing apparatus 500 performs the end processing.

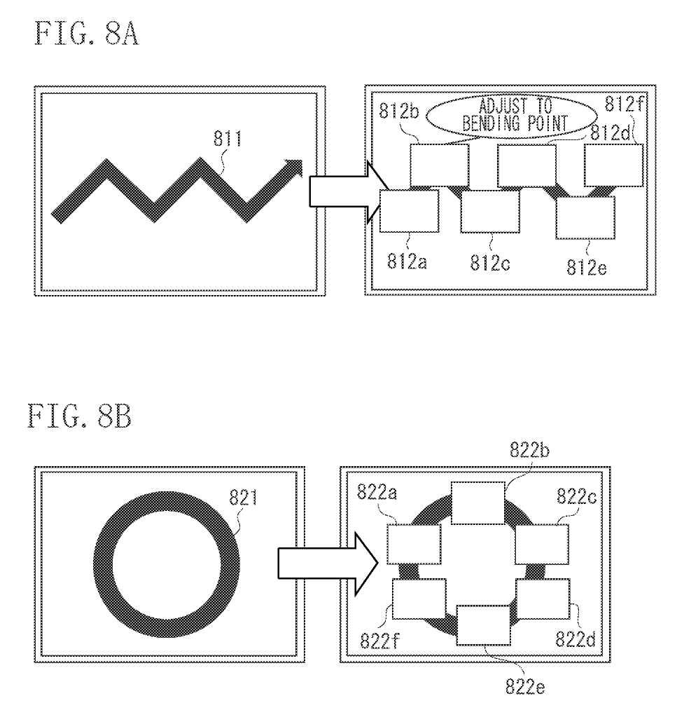

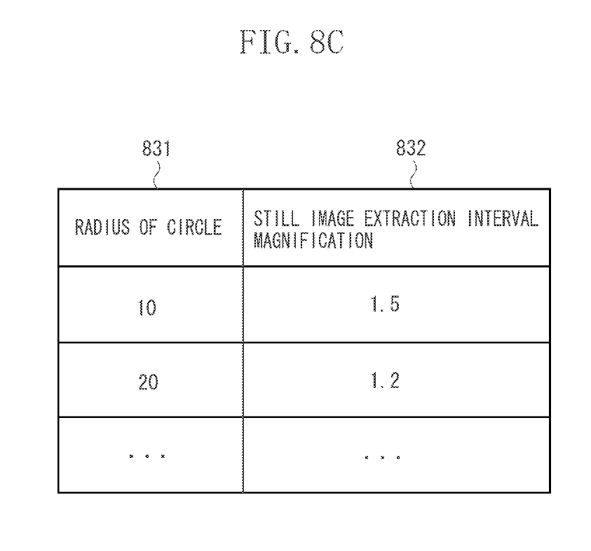

Here, a correct example of a shape of a locus will be described using FIG. 8A.

As illustrated in FIG. 8A, when the locus is a polygonal line 811, the drawing unit 501 records, at a time of drawing the locus, that a kind of the locus is a polygonal line, and notates a coordinate of a bending point of the polygonal line 811. The drawing reading unit 101 calculates a length of each coordinate respectively from the each recorded coordinate.

The extraction target still image determination unit 102 performs mapping of a moving image content according to each length of a locus calculated by the drawing reading unit 101, and determines a point for extracting the extraction target still image. The still image extraction unit 103 extracts a still image at the extraction point determined by the extraction target still image determination unit 102, and the still image display unit 301 displays the still images 812a, 812b, 812c, 812d, 812e, and 812f which are extracted on the bending points.

Further, another example is described using FIG. 8B. When a locus 821 drawn on a display is a circle or a curve containing a circle as illustrated in FIG. 8B, possibility of overlapping of still images 822a, 822b, 822c, 822d, 822e, and 822f becomes large at a time of displaying these still images if a curvature of the circle is small. Therefore, an interval for extracting a still image is adjusted beforehand.

For example, as illustrated in FIG. 8C, radiuses 831 indicating a size of a circle are held as a table. The drawing reading unit 101 calculates a length of a locus from a radius and an angle of a circle in a curve. The extraction target still image determination unit 102 calculates a product of a still image extraction interval 352 and still image extraction interval magnification 832 from the length of the locus calculated by the drawing reading unit 101, the table in FIG. 8C, and the still image size 351 in FIG. 3B, and determines a still image extraction interval.

In addition, the present invention is applicable as a part of a system configured with a plurality of devices or applicable as a part of an apparatus including one device. Further, the present invention is not limited to an apparatus and a method for realizing the aforementioned exemplary embodiments.

For example, supplying a program code of software for causing a computer within the aforementioned system or apparatus such as a central processing unit (CPU) or a micro-processing unit (MPU), to execute the aforementioned exemplary embodiments is also included in a category of the present invention. Further, a case that the computer in the aforementioned system or apparatus causes the aforementioned various kinds of devices to operate according to the program code and realizes the aforementioned exemplary embodiment is included in the category of the present invention.

In this case, the program code of software itself realizes functions of the aforementioned embodiment. More specifically, the program code itself and a method for supplying the program code to a computer, more concretely, a computer readable recoding medium storing the aforementioned program code, are included in the category of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-231767 filed Oct. 5, 2009, which is hereby incorporated by reference herein in its entirety.

What is claimed is:

1. An image processing apparatus comprising:
a drawing reading unit configured to read a drawn line on a display;
an extraction target still image determination unit configured to determine a point for extracting a still image from moving image data according to a locus read by the drawing reading unit;
a still image extraction unit configured to extract a still image from the moving image data based on a point determined by the extraction target still image determination unit; and
a still image display unit configured to display a still image extracted by the still image extraction unit, on the locus of the display.

2. The image processing apparatus according to claim 1, wherein the extraction target still image determination unit determines a point for extracting a still image according to quickness of a locus read by the drawing reading unit.

3. The image processing apparatus according to claim 1, wherein the extraction target still image determination unit determines a point for extracting a still image according to a shape of a locus read by the drawing reading unit.

4. An image processing method for controlling an image processing apparatus, the method comprising:
reading a line drawn on a display;
determining a point for extracting a still image from a moving image data according to the read locus;
extracting a still image from the moving image data based on the determined point;
displaying the extracted still image on the locus of the display.

5. The image processing method according to claim 4, wherein a point is determined for extracting a still image according to quickness of a locus read from the line drawn on the display.

6. The image processing method according to claim 4, wherein a point is determined for extracting a still image according to a shape of a locus read from the line drawn on the display.

7. A computer program causing a computer to execute an image processing method for controlling an image processing apparatus, the method comprising:
reading a line drawn on a display;
determining a point for extracting a still image from moving image data according to the read locus;
extracting a still image from the moving image data based on the determined point; and
displaying the extracted still image on the locus of the display.
